(19) United States
(12) Patent Application Publication
(10) Pub. No.: US 2020/0021481 A1
(43) Pub. Date: Jan. 16, 2020

(54) GENERIC AND EXTENSIBLE CLIENT AGENT FOR ENABLING THIRD PARTY COMMUNICATIONS

(71) Applicant: Microsoft Technology Licensing, LLC, Redmond, WA (US)

(72) Inventors: Ilias Tsigkogiannis, Kirkland, WA (US); Shri Vidhya Alagesan, Sammamish, WA (US); Arash Ghanaie - Sichanie, Woodinville, WA (US); Krishnan Ananthanarayanan, Redmond, WA (US); Matthew Vogel, Seattle, WA (US); Amit Kumar Dutta, Sammamish, WA (US); Rama Krishna Prasad Satya Prakash, Redmond, WA (US)

(21) Appl. No.: 16/034,944

(22) Filed: Jul. 13, 2018

(51) Int. Cl. H04L 12/24; H04L 29/06; H04L 29/08

(52) U.S. Cl. CPC H04L 41/046; H04L 69/18; H04L 67/20; H04L 67/141; H04L 67/104; H04L 67/12

(57) ABSTRACT

A network-connected service coupled to a network-connected device such as an IoT device implements a communication agent for a communication service that is separate from the network-connected service and that is implemented on the network-connected service to allow the network-connected device to establish communication sessions with other devices, not connected to the network-connected service. The communication agent may a component of a software development kit (SDK). The network-connected service receives an offer from the network-connected device and uses the communication agent to translate the offer into an compatible with the communication service. The communication agent sends the translated offer to the communication service with connection information sufficient to set up the session. The communication agent receives an offer answer from the second device and sends the offer answer to the network-connected device by posting the offer answer to a web address assigned to the network-connected device.

### BACKGROUND

Many commonplace devices are being enhanced using communication technology. One class of such devices are Internet of Things (IoT) devices. These devices include, without limitation, visible light communication (VLC) light fixtures, kitchen appliances, surveillance cameras, home controllers and smart speakers such as the Harman Kardon® Invoke®, the Amazon® Echo®, or the Google® Home. Communication-enhanced devices may be coupled to a network (e.g., the Internet) to communicate with a corresponding service available to the device via a network connection. Communication-enhanced devices generally and IoT devices in particular may use the network to transfer data and commands between the device and the service associated with the device. This service may be, for example, a network-connected service (e.g., a cloud service) accessed by the communication-enhanced device through the network.

### SUMMARY

This summary is not an extensive overview of the claimed subject matter. It is intended to neither identify key elements of the claimed subject matter nor delineate the scope of the claimed subject matter. Its sole purpose is to present some concepts of the claimed subject matter in a simplified form as a prelude to the more detailed description that is presented later.

According to one aspect, a network-connected service coupled to a network-connected device such as an IoT device implements, on the network-connected service, a communication agent for a communication service (e.g. a third-party communication service) that is different from the network-connected service to allow the network-connected device to establish communication sessions with other devices, not connected to the network-connected service. The communication agent may be a component of a software development kit (SDK). According to another aspect, the network-connected service receives an offer from the network-connected device and uses the communication agent to translate the offer into an offer compatible with the communication service and sends the translated offer to the communication service with connection information sufficient to set up the session.

According to another aspect, the signaling includes a web address assigned to the network-connected device. The network-connected device receives an offer answer from the other device via a posting to the web address.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description when considered in conjunction with the drawings.

### BRIEF DESCRIPTION OF THE DRAWINGS

FIG. 1 is a functional block diagram showing example components of a communication network including network-connected services that may be coupled by a communication service.

FIG. 2 is a functional block diagram of an example system including an IoT device, an IoT service, a communication service and a remote device useful for describing example embodiments.

FIGS. 3 and 4 are flow-chart diagrams useful for describing the operation of the system shown FIG. 2.

FIG. 5 is a flow-chart diagram useful for describing implementation of the system shown in FIG. 2.

FIGS. 6 and 7 are block diagrams of example hardware that may be used in an embodiment.

### DETAILED DESCRIPTION

The example embodiments below concern a method for implementing a communication system for network-connected devices using a software development kit (SDK) that is compatible with a communication service, such as, without limitation, Microsoft Skype®, Google Voice, Facebook® Messenger, WhatsApp®, and Viber Networks. The network-connected devices include, for example, Internet-of-Things (IoT) devices that include some processing capability but that interact with a network-connected service (e.g. a cloud service) to perform functions. An example network-connected device may include a smart speaker that interacts with a network-connected service to provide content requested by a user or control lighting or other appliances in the user's residence. The SDK includes a communication agent and other software modules that may be hosted on the network-connected service associated with the network-connected devices.

The network-connected service may not support telephone calls, collaboration sessions, or other media connections among the network-connected devices and devices outside of the local network. The network-connected service, however, may install the SDK to implement an interface to the communication service in order to provide the network-connected devices with the ability to place or receive calls, participate in collaboration sessions, make media connections and/or other communication sessions without the provider of the network-connected service having to incur the expense of implementing a dedicated interface to the communication service.

As described below the network-connected device may implement a communication protocol that interfaces with a communication agent that is compatible with the communication service and that has been implemented on the network-connected service as a part of the SDK. The network-connected device may then use the communication agent to set up a session between the network-connected device and a remote device using the SDK on the network-connected service to interface with the communication service. Alternatively, or in addition, the communication agent may allow a user of the network-connected device to join a collaboration session hosted by the communication service. The network-connected device may then communicate with remote devices either by a direct peer-to-peer connection or through the communication service. In some examples, the communication agent and other elements of the interface to the communication service are components of the SDK that is compatible with the communication service and that is implemented on the network-connected service.

The SDK provides a generic signaling interface between the network-connected service and the communication service and provides an application program interface (API) defining the commands and events to be provided by the network-connected device to set up a communication session using the communication service. Portions of the communication agent (e.g., the media agent) that would normally be implemented on the end-point device are, instead, implemented in the network-connected service. The implementation of the generic signaling interface allows different network-connected devices to access the communication service through the SDK implemented on the network-connected service used by the network-connected device. In order to enable these communication services, the network-connected service provider hosts the SDK and, based on the definition of the generic signaling interface, generates a specialized interface between the network-connected device and the generic signaling interface.

In some embodiments, the network-connected device includes a software module that implements a real-time protocol including a signaling/media stack which supports peer-to-peer communication. Examples of such a software module include WebRTC or the Skype signaling/media stack. While this real-time protocol supports peer-to-peer communication over a channel between devices, it provides only limited mechanisms for setting up the session. One solution would be for the network-connected service to implement a customized interface between the network-connected service and the communication service. This, however, may require considerable effort by the provider of the network-connected service. In embodiments described below, the network—the SDK is installed on connected service to implement the bulk of the interface to the communication service. The provider of the network-connected service implements an interface between the network-connected device and the communication agent of the SDK according to an API of the SDK. As such, the network-connected service may more easily implement a communication facility for its network-connected devices. This may be especially advantageous for IoT devices having limited computing resources. These devices may not have sufficient computing resources to implement a protocol to set up a communication session with the remote device without using resources of a communication service.

Using the SDK to implement the interface to the communication service may also be advantageous because it provides the network-connected service with the full range of capabilities of the communication service. For example, interfacing to a communication service configured to handle a variety of protocols (e.g., plain old telephone service (POTS), voice over Internet protocol (VoIP), screen sharing, and/or file transfer) may allow the network-connected devices to use these protocols with relatively little overhead.

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are examples and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include microprocessors, digital signal processors (DSPs), microcontrollers, computer systems, discrete logic components, and/or custom logic components such as field programmable gate arrays (FPGAs), application specific integrated circuits (ASICs), programmable logic arrays (PLAs) or the like.

As to terminology, the phrase “configured to” encompasses any way that any kind of functionality can be constructed to perform an identified operation. The functionality can be configured to perform an operation using, for example, software, hardware, firmware, or the like. For example, the phrase “configured to” can refer to a logic circuit structure of a hardware element that is arranged to implement the associated functionality. The phrase “configured to” can also refer to a logic circuit structure of a hardware element that is arranged to implement the coding design of associated functionality of firmware or software. The term “module” refers to a structural element that can be implemented using any suitable hardware (e.g., a processor, among others), software (e.g., an application, among others), firmware, and/or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any non-transitory computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

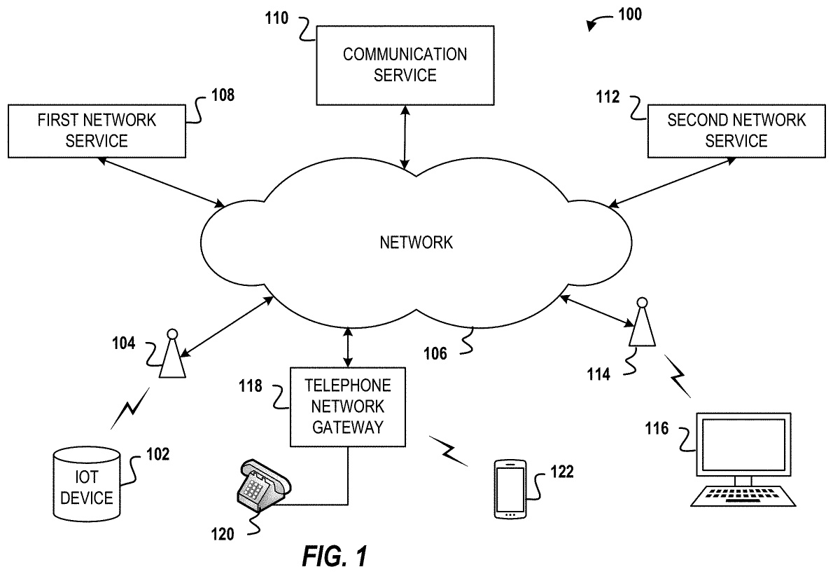

FIG. 1 is a block diagram showing an example network configuration 100 including an example embodiment. The examples described below use an IoT device 102 (e.g., a smart speaker device) as the network-connected device. It is contemplated, however, that the described embodiments may be used with other IoT devices (e.g. VLC light fixtures, kitchen appliances, surveillance cameras, and/or home controllers) or with any network-connected communication device associated with a network-connected service implementing the SDK.

The network configuration 100 includes a network-connected IoT device 102 that communicates with a first network-connected service 108 (also referred to as IoT service 108) via an access point 104 and a network 106 (e.g., the Internet). The IoT device 102 may access the first network-connected service 108 to provide data and/or to receive data and/or instructions for use by the first network-connected service 108; and/or to receive and/or provide data and/or instructions requested by a user of the IoT device 102. For example, the network-connected service 108 may collect data from an IoT home monitoring system or implement commands entered by a user of the home monitoring system via a smart speaker IoT device 102. The network configuration 100 also includes a communication service 110 coupled to the network 106 and a computing device 116 coupled to a second network-connected service 112 via an access point 114 and the network 106. The computing device 116 may be remote from the IoT device 102. The example network configuration 100 also includes a telephone network gateway 118 coupled to a wired telephone 120. As shown in FIG. 1, the telephone network gateway 118 may also implement a wireless connection to a mobile device such as user equipment (UE) 122.

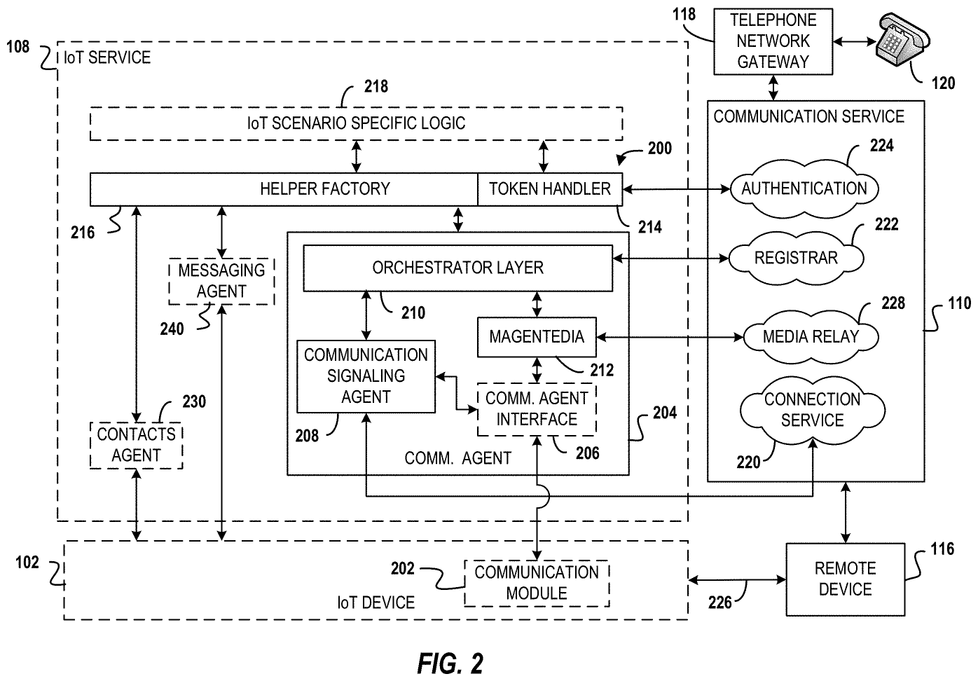

The materials that follow describe two scenarios with reference to FIGS. 2, 3, and 4. In a first scenario a user of the smart speaker IoT device 102 initiates a call to the telephone 120. In a second scenario, the user of the remote computing device 116 initiates a communication session with the IoT device 102 to receive data from the IoT device 102. In both of the scenarios described with reference to FIGS. 2, 3, and 4, the channel between the IoT device 102 and the telephone 120 or remote computing device 116 is set up using the communication service 110 in response to an offer generated by one of the devices and an answer provided by the other device. As used herein, “offer” refers to any request to establish a connection with another device and “answer” or “offer answer” refers to any response to such a request, either accepting or rejecting the offer.

Either the remote computing device 116 or the IoT device 102 may use the communication service 110 to set up a communication session to transmit/receive streaming media data. Streaming media data may be generated by or consumed by an IoT device 102 such as a smart speaker. The example IoT device 102 uses the SDK hosted by the IoT service 108 to interface with the communication service 110. The telephone 120 or remote computing device 116 may access the communication service 110 via a dedicated interface (e.g. the telephone network gateway 118 to which the telephone 120 is connected) or through another instance of the SDK running on the second network-connected service 112 to which the device 116 is connected. As described below, functionality, such as a communication agent and/or media agent, that is typically implemented in an endpoint device, such as the IoT device 102, may be at least partially implemented in the first network-connected service 108.

FIG. 2 shows an example embodiment in which a communication stack 200 for the communication service 110 is implemented in the IoT network-connected service 108 using the SDK that is compatible with the communication service 110. The use of the SDK and the communication service 110 to implement communication operations allows the first network-connected service to provide a robust communication facility to the IoT device 102 without incurring the expense of implementing a dedicated communication service. The communication stack 200 includes elements of the SDK (shown in solid lines) and elements (shown in dashed line boxes) implemented by the IoT service 108. The elements of the SDK include a communication agent 204 that includes a media agent 212, a communication signaling agent 208, and an orchestration layer 210. The communication stack 200 also includes a token handler 214 and a helper factory 216. In some embodiments, the helper factory 216 may raise events used by the IoT device 102 and the communication agent 204 to control the communication session. These events may include, for example, an incoming communication event, a hold event, a mute event, and an outgoing communication event. The communication agent interface 206 shown in dashed lines is implemented by the network-connected service 108 to integrate the SDK communication stack 200 into the network-connected service 108. The network-connected service also implements IoT scenario specific logic 218, a contacts agent 230, and a messaging agent 240. The IoT scenario specific logic 218 implements functions for the IoT device 102 that are specific to the IoT service 108. These may include, for example, a user interface, a web searching functionality, coordinating operation of linked IoT devices, and/or a data transfer functionality between connected IoT devices and between the IoT devices and the IoT service 108.

The IoT device 102 shown in FIG. 2 includes a communication module 202 that the IoT device 102 uses to communicate with its IoT network-connected service 108. FIG. 2 also shows components of the communication service 110 that interface with the IoT network-connected service 108 through the communication stack 200 of the SDK. These components include a connection service 220, a registrar 222, an authentication process 224, and a media relay 228. The communication service 110 communicates with the communication stack of the SDK via a secure connection through the network 106, as shown in FIG. 1. The elements shown in FIG. 2 may be used by the IoT network-connected service 108 to configure the IoT device 102 to communicate with the remote device 116 and/or the telephone network gateway 118 and telephones 120 and/or 122 using a communication session set up by the communication service 110. The media agent 212, communication agent interface 206 and orchestrator layer 210 determine how data traffic is handled once the connection is set up. The communication signaling agent 208 and connection service 220 set up and break down device-to-device connections.

In some embodiments, the communication module 202, may be an implementation of WebRTC, an open-source media platform, available from webrtc.org, that provides real-time communication via relatively simple APIs. Alternatively, the communication module 202 may implement any signaling/media stack that supports communication between the network-connected device (e.g., IoT device) 102 and the network-connected service (e.g. IoT service) 108. The communication module 202 allows audio, video, and data to be sent from and received by the IoT device 102 using a known media protocol and a known signaling protocol.

The media agent 212 is a portion of the SDK that handles media traffic in a manner that is compatible with the communication service 110. The communication agent interface 206 includes an interface between the media agent 212 and the communication module 202 of the IoT device 102. The communication agent interface 206 may also include an interface with the IoT scenario specific logic 218 so that it may recognize data including commands/messages/data sent to and/or received from the IoT scenario specific logic 218 by the IoT device 102 as well as offers, answers and connection information for the communication service 110 and route the data appropriately. This routing function may also be implemented in another module (not shown) of the IoT service 108 positioned between the IoT device 102 and the communication agent interface 206. In this implementation, only data intended for the communication service 110 is routed to the communication agent interface 206. All other data is routed to the IoT scenario specific logic 218.

The communication agent interface 206 is prepared by the IoT network-connected service 108 based on an API that is part of the SDK. An example API allows the IoT network-connected service access to the following objects:
Media Agent Factory—a top-level object used to create an instance of the Media Agent and also includes parameters such as the file path for the debugging log;
Communication Signaling Interface—allows creation and configuration of objects used during RTC communications (IConference objects) and also includes APIs to identify and select devices/functions such as a microphone, a speaker, a volume control, and a mute/unmute function.
IConference—an RTC session object that provides APIs for generating an offer for initiating an outbound communication and generating an answer when receiving an incoming communication.
INegotiation Offering—an object anchored on the IConference object to handle state management including helper factory events when IConference generates an offer for an outbound communication.
INegotiation Answering—an object anchored on the IConference object to handle state management including helper factory events for generating an answer when IConference receives an incoming communication.
   The API is a contract definition specifying commands and events for elements of the SDK implemented on the network-connected service 108. The API may also specify the order of the commands and events in order to set up, participate in, and tear down a communication session.

The communication agent interface 206 converts the media protocol, including signaling commands, used by a media stack (not shown) of the communication module 202 to a protocol that is compatible with the media agent 212 and the communication signaling agent 208. The interface implemented by the communication agent interface 206 is defined by the protocol used by the communication module 202 and by the API specified by the communication service 110 and used by the network-connected service 108 to implement the communication agent interface 206. The example orchestrator layer 210 is an aggregate layer that handles the communication session as a whole, both signaling and media. It is a communication manager that governs both media sessions and session set up and establishment.

Both outgoing and incoming communications operate according to a protocol of the communication module 202 and may include an offer or answer to set up and/or establish a session and connection information for the session including, without limitation, a ring signal for a telephone call session, the start of a communication session, when there is a problem with the session, and the end of a communication session. The offer/answer and the connection information is translated by the communication agent interface 206 for use by the communication stack 200 of the SDK and communication service 110. In the example system, this signaling is used by the communication signaling agent 208 of SDK and the connection service 220 of the communication service 110 to set up and tear down connections between the IoT device 102 and the telephone 120, mobile device 122 and/or the remote device 116. Because, in the example embodiment, communications are handled by the communication service 110, offers/answers and connection information sent to the telephone 120 and/or remote device 116 are handled by the connection service 220 of the communication service 110 so that the IoT device 102 can both send and receive communications.

When initiating a session through the IoT service 108, communication module 202 of the IoT device 102 may provide credentials such as identification information for the IoT device and/or a user name and password to the communication signaling agent 208 through the communication agent interface 206 (e.g. via the IConference object). The communication signaling agent 208, in turn, passes this information through the orchestration layer 210 to the token handler 214. The token handler 214 authenticates the IoT device 102 and may return a token that allows the IoT device 102 to access the communication service 110. The IoT device 102 passes the token through the communication agent interface 206 as connection information to gain access the communication service 110 when initiating a communication. Alternatively, or in addition, the authentication process may occur before initiation of a session, for example during an initial login to the system. In these embodiments the token may be stored in the IoT device 102 and passed to the connection service 220 of the communication service 110, via the communication agent interface 206 and the communication signaling agent 208 with the offer to set up the session.

The IoT device 102 may also register with the communication service 110 to receive incoming communications. Upon registering with the communication service 110, the IoT device 102 may be assigned a uniform resource locator (URL) web address by the registrar 222 so that the IoT device 102 may receive incoming communications. In the materials that follow, this URL web address is referred to as a webhook URL. The registrar 222 interfaces with the orchestrator layer 210 to handle signaling and media streams for incoming communications to the IoT device 102 and to raise the appropriate events in the helper factory 216.

Connection information for establishing a session from the remote device 116 to the IoT device 102 may begin with the remote device issuing an offer to set up a session with the IoT device 102, using an identifier (e.g., a telephone number or network address) for the IoT device 102. The identifier may be the webhook URL or may be translated by the registrar into the webhook URL. The connection service 220 may post the offer to the webhook URL in a manner similar to a secure hypertext transmission (HTTPS) service to send the offer to the communication module 202, via the connection signaling agent 208 and the communication agent interface 206, to set up the connection to the IoT device 102. The IoT device 102 may send an offer acceptance to the remote device 116 through the communication agent interface to notify the remote device 116 that the session has been set up.

Once a session is set up, if both devices have compatible communication modules (e.g., both devices are running WebRTC) and the offer from the remote device 116 was for a peer-to-peer connection, the connection service 220 can set up a direct peer-to-peer connection between the IoT device 102 and the remote device 116, as indicated by the signal line 226 shown in FIG. 2. The peer-to-peer session may be set up by sending signals to the communication module 202 including a network address of the remote device 116 so that the IoT device 102 may contact the remote device 116 via the network 106, outside of the communication service 110. This network address may be included in the offer or answer from the remote device 116. Similarly, a network address for the IoT device 102 may be included in the offer or answer sent to the remote device 116.

Alternatively, when the communication is routed through the communication server 110, media may be provided to the communication stack 200 via the media relay 228 which interfaces with the media agent 212 to receive media from and/or provide media to the IoT device 102 via the communication agent interface 206. When the IoT device 102 and the remote device 116 exchange streaming media data it may be advantageous to set up the peer-to-peer connection rather than using the media relay and media agent as streaming media may incur charges for using bandwidth of the communication service 110.

The communication service 110 may also have a dedicated connection (not shown) to the telephone network. The connection service 220 of the communication service 110 may resolve a telephone number either provided by the communication module 202 or obtained via the contacts agent 230 to identify the telephone 120 and send the connection information directly to the telephone network gateway 118. When the communication is to a client registered with the communication service 110, the connection service 220 may send the connection information identifying the other party to the registrar 222 to determine how to send the offer to the other party.

The contacts agent 230 and messaging agent 240 are parallel stacks to the communication stack 200. The contacts agent 230 may be defined by an API and, when implemented, may coordinate the contact lists of the IoT network-connected service 108 and, in particular, the contact list of the IoT device 102, with the communication service 110. In some embodiments, the IoT device 102 may have a contacts list which it may pass to the communication service 110 via the contacts agent 230. The communication signaling agent 208 and the connection service 220 may use information provided via the contacts agent 230 to generate contact information used to set up a communication session using the communication stack 200. For example, the contacts agent 230 may link a contact obtained from the IoT device 102 to an identifier specific to the communication service 110, for example, a Skype ID and provide the identifier as contact information with the offer. When the IoT device includes telephone contacts, such as telephone numbers, however, the communication module 202 may provide the number to the communication agent interface 206 and communication signaling agent 208 directly, without using the contacts agent 230. The contacts agent can also be used to train the call signaling agent 208 and/or the connection service 220 on the contact names to learn how to pronounce/recognize the names as well as to implement different contact methods (home, mobile, work, etc.) when dealing with a voice-driven interface.

The messaging agent 240 handles text messages. The messaging agent 240 may include an API in the SDK that is compatible with the communications service 110. The API may define signaling and events used to send and receive text messages using the communication service 110. The messaging agent 240 may interface with the contacts agent 230 to obtain information used to set up a messaging connection with the remote device 116, telephone 120, telephone 122, or other communication device accessible via the communication service 110. The contacts agent 230 and messaging agent 240 may provide contact information to the communication signaling agent 208 either directly or via the orchestrator layer 210.

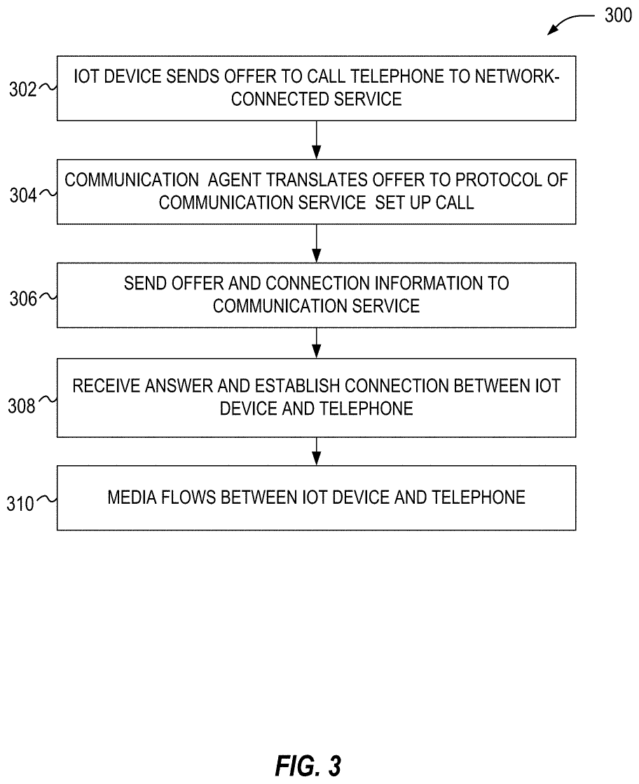

FIG. 3 is a flowchart diagram of a process 300 in which the IoT device 102 initiates a communication session (e.g., calls) a user device, in this example, the telephone 120. At block 302, the IoT device 102 passes an offer to call the telephone 120 to the communication agent interface 206. This offer includes connection information (e.g., a telephone number) for the telephone 120 obtained from local contacts or contacts of the IoT device 102 or via the contacts agent 230. The connection information may also include the token obtained from the authentication process 224. The communication agent interface 206, at block 304, translates the offer and connection information into a protocol compatible with the communication service 110 and passes the offer and connection information to the communication signaling agent 208. At block 306, the communication signaling agent 208, in turn, passes the offer with the contact information to the connection service 220 which identifies the telephone 120 based on the provided number sets up the call by sending the offer to the telephone network gateway 118. The communication signaling agent 208 may also notify the orchestrator layer 210 of the offer so that the orchestrator layer 210 may monitor the communication signaling and cause the helper factory 216 to raise the appropriate events

The gateway 118 handles signaling for the connection to the telephone 120. At block 308, the connection service 220 may receive a call answer from the gateway 118 and may send the answer to the communication signaling agent 208. Also in block 308, the communication signaling agent 208, in turn, accesses the helper factory to raise an event indicating that the call is established. The communication signaling agent, in block 308, also sends the offer answer to the communication agent interface 206 to notify the communication module 202 that the call is established. The flag in the helper factory triggers the connection service 220 to set up a media connection between the IoT device 102 and the telephone 120 in block 310. In this example, the media connection may be set up via the telephone network gateway 118, the media relay 228, the media agent 212 and the communication agent interface 206.

In one example, the user may engage the smart speaker IoT device 102 by saying “call home.” In response to this command, the IoT device 102, if it has not already registered with the communication stack 200, may provide its credentials (e.g. username and password) to the communication signaling agent 208 which, in turn, provides the credentials to the token handler 214 to authenticate the IoT device and to obtain a token allowing the IoT device 102 to access the communication service 110. Concurrently, the IoT device 102 may search the contacts agent 230 to obtain the phone number or web address associated with the word “home” for the IoT device 102. In this example, the contacts agent 230 provides the telephone number of the telephone 120 to the communication module 202 to be included in the offer. Alternatively, the contacts agent 230 may provide the telephone number to the communication signaling agent 208 and/or the connection service 220 to be used to route the offer to the telephone network gateway 118.

At block 308, after receiving the answer, the communication stack 200 may negotiate the session description protocol (SDP) used to establish the communication session between the IoT device 102 and the telephone 120. The success or failure of the attempt to set up the session is communicated to telephone network gateway 118 via a return message containing a result object from the communication signaling agent 208 and/or the communication module 202 of the IoT device 102, translated by the communication agent interface 206. When the telephone network gateway 118 signals acceptance of the connection at block 310, media, in this case voice data, flows between the IoT device 102 and the telephone 120. While the communication session is being set up, connection information may be fed back from the communication stack 200 to the IoT device 102. This connection information may include, for example, ring signals indicating that the communication service 110 is trying to set up the connection with the telephone 120. As described above, because the telephone 120 does not support peer-to-peer communication the channel between the IoT device 102 and the telephone 120 uses the communication service 110 and interfaces with the IoT device 102 via the media relay 228, the Media agent 212 and the communication agent interface 206.

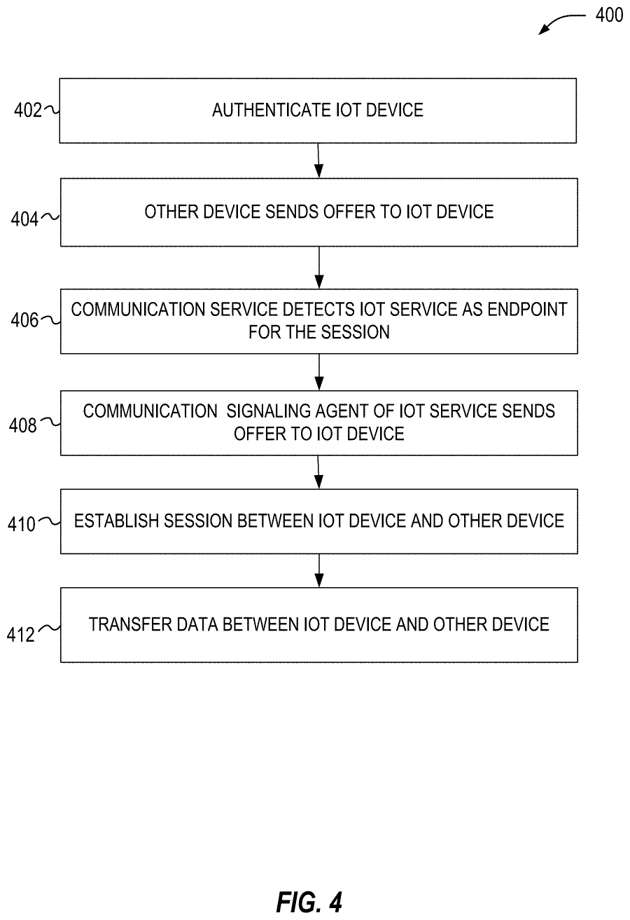

FIG. 4 is a flow-chart diagram of an example process 400 by which a device, such as the remote device 116, may set up a connection with the IoT device 102 using the communication service 110. At block 402, the remote device 116 provides its credentials to the authentication process 224 of the communication service 110. When the device 116 is coupled to another network-connected service (e.g., the second network-connected service 112 shown in FIG. 1), the credentials may be passed through the token handler of that service. Alternatively, the remote device 116 may be a client of the communication service and may access the service, for example, via a dedicated application or via a plug-in on a browser running on the remote device 116. Upon receiving the credentials, the authentication process 224 may provide a token to the remote device 116 as described above with reference to the IoT device 102.

At block 404, the connection service 220 receives an offer from the remote device 116. The offer may include the token and information identifying the IoT device. Prior to block 402, the IoT device 102 had registered with the communication service 110 and the registrar 222 had assigned a webhook URL to the IoT device 102, as described above. Consequently, at block 406, when the connection service 220 receives the offer from the remote device 116, the connection service 220 may pass the information identifying the IoT device 102 to the registrar 222 which returns the webhook URL to the connection service 220. Alternatively, the remote device 116 may know the webhook URL from a previous session and provide it directly to the connection service 220 with the offer. The connection service 220 then sends the offer to the IoT device 102 by posting a message to the webhook URL in a manner similar to an HTTPS post.

When the remote device 116 is coupled to another network-connected service, for example, the network-connected service 112, shown in FIG. 1, the remote device 116 may be associated with another webhook URL that has been registered with the registrar 222. In this instance, the IoT device 102 may generate an offer answer and notify the remote device 116 via the other webhook URL while also notifying the call signaling agent interface of the answer. Alternatively, when the other party has an address known to the communication service 110, the IoT device 102, using the communication agent interface 206 may construct the communication workflow, including the offer answer, and send the workflow to the connection service 220 via the communication signaling agent 208. In response to receiving the answer, the communication signaling agent 208 sends an answer to the remote device 116 via the connection service 220. In response to the offer and/or the answer, the connection service 220, via the orchestrator layer 210, may also instruct the helper factory 216 to raise the appropriate communication state change notifications (e.g., session start, session end, ring, hold, unhold, hangup, etc.)

At block 408, the communication stack 200 negotiates the session description protocol (SDP) used to set up the communication session with the remote computing device 116. The success or failure of the communication set up is communicated to the IoT device 102 via a response containing a session result object from the remote computing device 116. When the IoT device signals acceptance of the connection, the connection service 220 sets up the peer-to-peer connection between the remote computing device 116 and the IoT device 102, at block 410, as indicated by the arrow 226 in FIG. 2. This connection does not use the communication service 110. Instead, it is a peer-to-peer connection set up through the network 106 using the protocol of the communication module (e.g., WebRTC). The peer-to-peer communication may be between the webhook URL assigned to the web-connected device 102 and the other webhook URL assigned to the remote device 116. Once the connection is set up, the IoT device 102 and remote computing device 116 may transfer data as indicated by block 412. Communication status information may be maintained, for example, using events raised in the helper factory 216 by connection information sent from the IoT device to the communication agent interface 206 even though the media connection is a peer-to-peer connection.

Once all the processing of the media streams is completed the IoT device 102 may end the communication session, for example, by sending an HTTP Delete to a URL for the remote computing device 116. This URL may be contained in the session result object that was received by the IoT device 102 from the remote computing device 116. Upon receiving the HTTP Delete, the remote computing device 116 may send a response message to the communication stack 200, via the connection service 220. The response message may contain a communication state change notification having a “terminated” state. In response to this message, the communication signaling agent 208 signals the communication service 110 to breakdown the connection between the remote computing device 116 and the IoT device 102. The communication signaling agent 208 may also signal the helper factory 216 to change the appropriate events to indicate the terminated communication session.

Although FIG. 3 is described in terms of the IoT device 102 providing the offer and the telephone network gateway 118 providing the offer answer, it is contemplated that these roles may be reversed such that the telephone 120, through the telephone network gateway 118 generates the offer and the IoT device 102 generates the response. The offer to the IoT device 102, however, may be posted to the IoT device 102 by the connection service 220 using the webhook URL or translated to the protocol used by the IoT device 102 via the communication agent interface 206. Similarly, a communication from the IoT device 102 to the remote device 116 may proceed as described in FIG. 3 except that, when the remote device 116 is coupled to a network-connected service implementing the SDK, the connection service 220 may post the offer to a webhook URL assigned to the remote device 116.

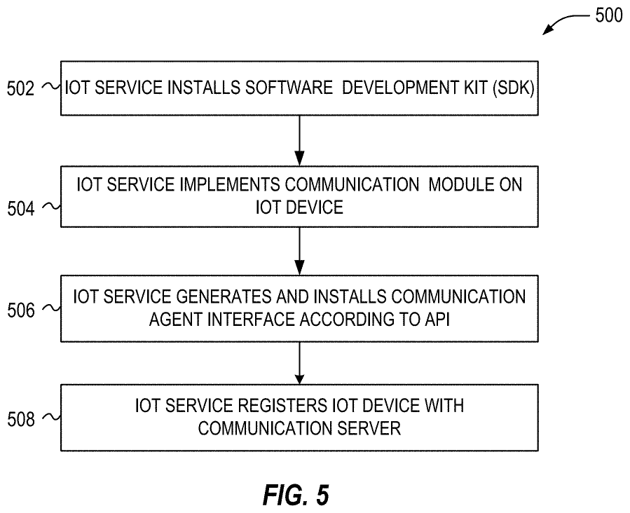

FIG. 5 is a flow-chart diagram describing a process 500 for implementing the SDK in the IoT service 108. At block 502, the IoT service 108 installs the SDK on a network-connected server of the network connected service 108 that may be accessed by the IoT device 102. This installation provides the network-connected IoT service 108 with the components of an interface to the communication service as described above. These components include the communication agent 204 comprising the communication signaling agent 208, the media agent 212 and the orchestration layer 210. In addition, the installed components include the token handler 214 and the helper factory 216. Next, at block 504, the IoT service implements the communication module 202 on the IoT device 102. This step is optional if the IoT device is already configured with a communication module such as WebRTC, as described above. The communication module 202 may be the sole communication module implemented in the IoT device 102 and thus may handle communications between the IoT module and the IoT scenario specific logic 218 as well as communications through the communication service 110. Alternatively, the communication module 202 may handle only communications through the communication service 110.

Block 506 generates and installs the communication agent interface 206 according to the API in the SDK to translate connection information in the protocol used by the IoT device 102 into connection information in a protocol compatible with the communication service 110. When the communication module 202 handles both communication with the IoT scenario specific logic 218 and communication through the communication service 110, the communication agent interface may include code that recognizes the two types of communication and routes them appropriately. Alternatively, this code may be implemented in a separate module (not shown) of the network-connected service 108. This code may not be needed when the communication module 202 handles only communication through the communication service 110.

As described above, the communication agent interface 206 interfaces the communication and media signaling from the communication module 202 of the IoT device 102 with the communication signaling agent 208 and media agent 212 according to the API for the communication agent interface 206 in the SDK. The SDK may also include code for a model communication agent interface 206 that may be adapted to work with the communication module 202. Depending on the implementation, block 506 may also entail generating code according to APIs for interfacing the contacts agent 230 and messaging agent 240 with the SDK. Finally, at block 508, the IoT service 108 may register the IoT device 102 with the communication service 110, for example, by passing a username and password from the IoT device 102 to the authentication process 224, as described above. At block 508, the IoT service 108 may also receive the token from the token handler 214 and the webhook URL may be registered by the registrar 222.

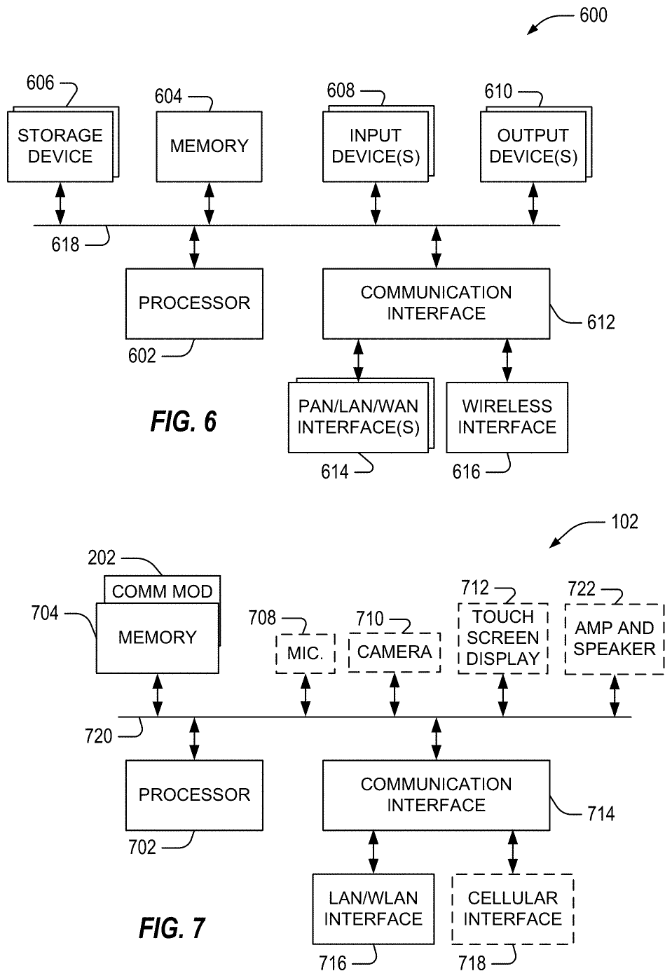

FIG. 6 is a block diagram of an example processing system 600 that may be used as a network-connected server for the IoT service 108, communication network-connected service 110, second network-connected service 112, or the remote computing device 116 shown in FIG. 1. The system 600 includes a processor 602 coupled to a bus 618. Also coupled to the bus 618 are a memory 604, which may include a flash memory device, random access memory (RAM) and/or read only memory (ROM); a mass storage device 606, such as a RAID disk array or a solid-state disk; one or more input devices 608, such as a keyboard or a pointing device; and one or more output devices 610, such as a display screen. The memory 604 may store computer instructions for applications that are currently running on the system 600. For example, when the system shown in FIG. 6 is a server of the network-connected service 108, the memory may contain all of the modules shown in block 108 of FIG. 2, including the SDK modules.

The bus 618 also connects the system 600 to a communication interface 612, for example, to provide communication between the system 600 and the network 106 shown in FIG. 1. The communications interface 612 may be coupled to a LAN/WLAN interface 614 such as a wired or optical Ethernet connection or wireless connection (e.g., IEEE 802.11 or IEEE 802.15). In addition, the communication interface 612 may be coupled to an interface 614 to one or more of a personal area network (PAN), local area network (LAN) or Wide area network (WAN). In addition, the communication interface may be coupled to a wireless interface 616. The interfaces 614 and 616 may be coupled to respective transceivers and/or modems (not shown) to implement the data communications operations.

Processor 602 may include a microprocessor, microcontroller, digital signal processor (DSP) that is configured to execute commands stored in the memory 604 corresponding to the programs (Internet browsers, application program interfaces (APIs), dynamically linked libraries (DLLs), or applications (APPs)) described above. The memory 604 may also store temporary variables, the clipboard, or other information used in the execution of these programs. The programs stored in the memory 604 may be retrieved by the processor from a separate computer readable medium, for example, a flash memory device, a CD-ROM, or digital versatile disk (DVD).

FIG. 7 is a block diagram of an example processing system 700 that may be used as the IoT device 102 shown in FIG. 1. The processing system 700 may be, for example, a smart speaker. The system 700 includes a processor 702 coupled to a bus 720. Also coupled to the bus 720 are a memory 704, which may include a flash memory device, random access memory (RAM) and/or read only memory (ROM); an optional microphone 708; an optional camera 710; an optional input and/or output device 712, such as a touch screen display; and an optional amplifier and speaker 722. The bus 720 also connects the system 700 to a communication interface 714, for example, to provide communication between the system 700, as the IoT device 102, and the access point 104. It is contemplated that the amplifier and speaker 722 may be coupled directly to an analog output port of the processor 702 rather than to the bus 720.

The memory 704 may store computer instructions for applications that are currently running on the system 700. The communications interface 714 may be coupled to a LAN/WLAN interface 716 such as a wired or optical Ethernet connection or wireless connection (e.g., IEEE 802.11 or IEEE 802.15). In addition, the communications interface 714 may be coupled to a wireless interface such as a cellular interface 718. The interfaces 716 and 718 may be coupled to respective transceivers and/or modems (not shown) to implement the data communications operations. As described above, one of the applications stored in the memory 704 may be the communication module 202, shown in FIG. 2.

Processor 702 may include a microprocessor, microcontroller, digital signal processor (DSP) that is configured to execute commands stored in the memory 704 corresponding to the programs (Internet browsers, application program interfaces (APIs), dynamically linked libraries (DLLs), or applications (APPs)) described above. The memory 704 may also store temporary variables, the clipboard, or other information used in the execution of these programs. The programs stored in the memory 704 may be retrieved by the processor from a separate computer readable medium, for example, a flash memory device, a CD-ROM, or digital versatile disk (DVD).

### Examples

Example 1 is an apparatus of a first network-connected service for setting up a communication session between a first network-connected device, configured to communicate with the first network-connected service, and a second device using a communication service different from the first network-connected service, the apparatus comprising: a processor; a memory, coupled to the processor, the memory including instructions that, when executed by the processor, control the apparatus to: receive, at the first network-connected service, an offer to set up the communication session with the second device, the offer being in a first protocol used by the first network-connected device; determine that the offer is directed to the communication service; translate the offer into a second protocol, different from the first protocol, the second protocol being compatible with the communication service; and send the translated offer to the communication service, with connection information sufficient for the communication service to set up the communication session between the first network-connected device and the second device.

In Example 2, the subject matter of Example 1 includes, wherein the memory further comprises a communication agent that configures the processor to receive an answer to the offer and to establish the communication session between the first network-connected device and the second device in response to the answer indicating acceptance of the offer.

In Example 3, the subject matter of Example 2 includes, wherein the first network-connected device is an Internet of things (IoT) device and the instructions configure the processor to set up the communication session between the first network-connected device and the second device to convey streaming media data.

In Example 4, the subject matter of Examples 2-3 includes, wherein the communication agent further configures the processor to maintain session status events associated with the communication session.

In Example 5, the subject matter of Examples 1-4 includes, wherein the instructions further configure the processor to: assign a web address to the first network-connected device; and receive an offer answer from the second device and to post the offer answer to the web address assigned to the first network-connected device.

In Example 6, the subject matter of Examples 2-5 includes, a communication agent interface that configures the processor to translate the offer in the first protocol to the offer in the second protocol and to send the translated offer with the connection information to the communication interface, wherein the connection information is sufficient to set up the communication session as a peer-to-peer communication session between the first network-connected device and the second device.

In Example 7, the subject matter of Examples 1-6 includes, wherein the translated offer and connection information sent to the communication service includes connection information sufficient to set up the session with the second device through a second network-connected service coupled to the second device and to the communication service.

Example 8 is a computer readable medium including instructions which, when executed by a processor of a network-connected service, configure the processor to: receive, at the network-connected service, an offer to set up a communication session between a first network-connected device and a second device, the offer being in a first protocol used by the first network-connected device; determine that the offer is directed to a communication service different from the network-connected service; translate the offer into a second protocol, different from the first protocol, the second protocol being compatible with the communication service; and send the translated offer to the communication service, with connection information sufficient for the communication service to set up the communication session between the first network-connected device and the second device.

In Example 9, the subject matter of Example 8 includes, wherein the instructions further comprise a communication agent that configures the processor to receive an answer to the offer and to establish the communication session between the first network-connected device and the second device in response to the answer indicating acceptance of the offer.

In Example 10, the subject matter of Example 9 includes, a communication agent interface that configures the processor to translate the offer in the first protocol to the offer in the second protocol and to send the translated offer with the connection information to the communication interface, wherein the connection information is sufficient to set up the communication session as a peer-to-peer communication session between the first network-connected device and the second device.

In Example 11, the subject matter of Examples 9-10 includes, wherein the communication agent is a component of a software development kit (SDK), compatible with the communication service, and configured to be implemented in the network-connected service, and is configured to maintain session status events associated with the communication session.

In Example 12, the subject matter of Examples 9-11 includes, wherein the communication agent further configures the processor of the network-connected service to: receive an offer answer from the second device; and post the offer answer to a web address associated with the first network-connected device.

Example 13 is a method comprising: receiving by a processor of a network-connected service, an offer to set up a communication session between a first network-connected device and a second device, the offer being in a first protocol used by the first network-connected device; determining that the offer is directed to a communication service different from the network-connected service; translating the offer into a second protocol, different from the first protocol, the second protocol being compatible with the communication service; and sending the translated offer to the communication service with connection information sufficient for the communication service to set up the communication session between the first network-connected device and the second device.

In Example 14, the subject matter of Example 13 includes, receiving an answer to the offer and establishing the communication session between the first network-connected device; and posting the offer answer to a web address associated with the first network-connected device to establish the communication session between the first network-connected device and the second device.

In Example 15, the subject matter of Example 14 includes, setting up a peer-to-peer communication session as the communication session between the first network-connected device and the second device.

In Example 16, the subject matter of Examples 14-15 includes, maintaining, by the network-connected service, session status events associated with the communication session.

Example 17 is apparatus comprising: means for receiving by a processor of a network-connected service, an offer to set up a communication session between a first network-connected device and a second device, the offer being in a first protocol used by the first network-connected device; means for determining that the offer is directed to a communication service different from the network-connected service; means for translating the offer into a second protocol, different from the first protocol, the second protocol being compatible with the communication service; and means for sending the translated offer to the communication service with connection information sufficient for the communication service to set up the communication session between the first network-connected device and the second device.

In Example 18, the subject matter of Example 17 includes, means for receiving an answer to the offer; and means for establishing the communication session between the first network-connected device and the second device in response to the answer indicating acceptance of the offer.

In Example 19, the subject matter of Examples 17-18 includes, means for posting the offer answer to a web address associated with the first network-connected device to set up the communication session between the first network-connected device and the second device.

In Example 20, the subject matter of Examples 17-19 includes, means for maintaining, by the network-connected service, session status events associated with the communication session.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the scope of the appended claims.

In particular and in regard to the various functions performed by the above described components, devices, circuits, systems and the like, the terms used to describe such components are intended to correspond, unless otherwise indicated, to any component which performs the specified function of the described component, e.g., a functional equivalent, even though not structurally equivalent to the disclosed structure, which performs the function in the example illustrated aspects of the claimed subject matter. In this regard, it will also be recognized that the disclosed example embodiments and implementations include a system as well as computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned example systems have been described with respect to interaction among several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

Furthermore, while a particular feature of the claimed subject matter may have been disclosed with respect to one of several implementations, such feature may be combined with one or more other features of the other implementations as may be desired and advantageous for any given or particular application. In addition, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. An apparatus of a first network-connected service for setting up a communication session between a first network-connected device, configured to communicate with the first network-connected service, and a second device using a communication service different from the first network-connected service, the apparatus comprising:
a processor;
a memory, coupled to the processor, the memory including instructions that, when executed by the processor, control the apparatus to:
receive, at the first network-connected service, an offer to set up the communication session with the second device, the offer being in a first protocol used by the first network-connected device;
determine that the offer is directed to the communication service;
translate the offer into a second protocol, different from the first protocol, the second protocol being compatible with the communication service; and
send the translated offer to the communication service, with connection information sufficient for the communication service to set up the communication session between the first network-connected device and the second device.

2. The apparatus of claim 1, wherein the memory further comprises a communication agent that configures the processor to receive an answer to the offer and to establish the communication session between the first network-connected device and the second device in response to the answer indicating acceptance of the offer.

3. The apparatus of claim 2, wherein the first network-connected device is an Internet of things (IoT) device and the instructions configure the processor to set up the communication session between the first network-connected device and the second device to convey streaming media data.

4. The apparatus of claim 2, wherein the communication agent further configures the processor to maintain session status events associated with the communication session.

5. The apparatus of claim 1, wherein the instructions further configure the processor to:
assign a web address to the first network-connected device; and
receive an offer answer from the second device and to post the offer answer to the web address assigned to the first network-connected device.

6. The apparatus of claim 2, further comprising a communication agent interface that configures the processor to translate the offer in the first protocol to the offer in the second protocol and to send the translated offer with the connection information to the communication interface, wherein the connection information is sufficient to set up the communication session as a peer-to-peer communication session between the first network-connected device and the second device.

7. The apparatus of claim 1, wherein the translated offer and connection information sent to the communication service includes connection information sufficient to set up the session with the second device through a second network-connected service coupled to the second device and to the communication service.

8. A computer readable medium including instructions which, when executed by a processor of a network-connected service, configure the processor to:
receive, at the network-connected service, an offer to set up a communication session between a first network-connected device and a second device, the offer being in a first protocol used by the first network-connected device;
determine that the offer is directed to a communication service different from the network-connected service;
translate the offer into a second protocol, different from the first protocol, the second protocol being compatible with the communication service; and
send the translated offer to the communication service, with connection information sufficient for the communication service to set up the communication session between the first network-connected device and the second device.

9. The computer readable medium according to claim 8, wherein the instructions further comprise a communication agent that configures the processor to receive an answer to the offer and to establish the communication session between the first network-connected device and the second device in response to the answer indicating acceptance of the offer.

10. The computer readable medium according to claim 9, further comprising a communication agent interface that configures the processor to translate the offer in the first protocol to the offer in the second protocol and to send the translated offer with the connection information to the communication interface, wherein the connection information is sufficient to set up the communication session as a peer-to-peer communication session between the first network-connected device and the second device.

11. The computer readable medium according to claim 9, wherein the communication agent is a component of a software development kit (SDK), compatible with the communication service, and configured to be implemented in the network-connected service, and is configured to maintain session status events associated with the communication session.

12. The computer readable medium according to claim 9, wherein the communication agent further configures the processor of the network-connected service to:
receive an offer answer from the second device; and
post the offer answer to a web address associated with the first network-connected device.

13. A method comprising:
receiving by a processor of a network-connected service, an offer to set up a communication session between a first network-connected device and a second device, the offer being in a first protocol used by the first network-connected device;
determining that the offer is directed to a communication service different from the network-connected service;
translating the offer into a second protocol, different from the first protocol, the second protocol being compatible with the communication service; and
sending the translated offer to the communication service with connection information sufficient for the communication service to set up the communication session between the first network-connected device and the second device.

14. The method according to claim 13, further comprising:
receiving an answer to the offer and establishing the communication session between the first network-connected device; and
posting the offer answer to a web address associated with the first network-connected device to establish the communication session between the first network-connected device and the second device.

15. The method according to claim 14, further comprising setting up a peer-to-peer communication session as the communication session between the first network-connected device and the second device.

16. The method according to claim 14, further comprising maintaining, by the network-connected service, session status events associated with the communication session.

17. Apparatus comprising:
means for receiving by a processor of a network-connected service, an offer to set up a communication session between a first network-connected device and a second device, the offer being in a first protocol used by the first network-connected device;
means for determining that the offer is directed to a communication service different from the network-connected service;
means for translating the offer into a second protocol, different from the first protocol, the second protocol being compatible with the communication service; and
means for sending the translated offer to the communication service with connection information sufficient for the communication service to set up the communication session between the first network-connected device and the second device.

18. The apparatus according to claim 17, further comprising:
means for receiving an answer to the offer; and
means for establishing the communication session between the first network-connected device and the second device in response to the answer indicating acceptance of the offer.

19. The apparatus according to claim 17, further comprising means for posting the offer answer to a web address associated with the first network-connected device to set up the communication session between the first network-connected device and the second device.

20. The apparatus according to claim 17, further comprising means for maintaining, by the network-connected service, session status events associated with the communication session.
